(19) United States
(12) Patent Application Publication
(10) Pub. No.: US 2026/0360174 A1
(43) Pub. Date: Nov. 12, 2026

(54) INFORMATION PROCESSING APPARATUS, INFORMATION PROCESSING METHOD, AND NON-TRANSITORY COMPUTER READABLE STORAGE MEDIUM

(71) Applicant: CANON KABUSHIKI KAISHA, Tokyo (JP)

(72) Inventor: YUKI OSHIMA, Tokyo (JP)

(21) Appl. No.: 19/661,990

(22) Filed: Apr. 29, 2026

(30) Foreign Application Priority Data
May 7, 2025 (JP) 2025-077322

(51) Int. Cl. G06V 30/26; G06V 10/94; G06V 30/40; H04N 1/00

(52) U.S. Cl. CPC G06V 30/26; G06V 10/945; G06V 30/40; H04N 1/00331; H04N 2201/0094

(57) ABSTRACT

The present disclosure allows a user to easily understand a constructed correction rule. An image processing unit determines whether the user corrects a character string, and in a case where the user corrects the character string, the image processing unit performs processing of constructing a correction rule (correction rule construction processing). In a case where the correction rule is constructed, the image processing unit performs processing of generating a description text of the correction rule (correction rule description text generation processing). A displaying control unit displays the generated description text of the correction rule on a displaying and operation unit to present it to the user, accepts a user direction for the correction rule, and sets automatic application of the correction rule.

### BACKGROUND

### Field of the Technology

The present disclosure relates to an information processing technique to correct an inputted character string.

### Description of the Related Art

Conventionally, there has been a system to set a file name of a document image, which is obtained by scanning a paper document, based on a character recognition result obtained by performing character recognition processing on the document image. Japanese Patent Laid-Open No. 2021-163178 describes that, in a case where attribute information is applied to the document image based on a character string obtained by performing the character recognition processing on the document image, correction contents that a user performs on the obtained character string are learned, and a correction rule corresponding to the learned correction contents is constructed. In Japanese Patent Laid-Open No. 2021-163178, it is possible to automatically perform correction on the character string obtained from a similar document image based on the constructed correction rule.

### SUMMARY

The present disclosure includes: an obtainment unit configured to obtain a character string included in an inputted document image and a post-correction character string corrected from the character string by a user; a generation unit configured to generate a correction rule to obtain the post-correction character string from the character string based on the character string and the post-correction character string; and an output unit configured to output description information including a description text of the correction rule generated by the generation unit.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of a system according to an embodiment;

FIG. 2 is a diagram illustrating a hardware configuration example of an image formation apparatus according to an embodiment;

FIG. 3 is a diagram illustrating a functional configuration of the image formation apparatus according to an embodiment;

FIG. 4 is a flowchart describing file generation processing of a scanned image according to Embodiment 1;

FIG. 5A is a diagram illustrating the scanned image obtained by character string area detection processing according to Embodiment 1;

FIG. 5B is a diagram illustrating a result of the character string area detection processing according to Embodiment 1;

FIG. 6 is a diagram illustrating an example of a registered document record according to Embodiment 1;

FIG. 7 is a diagram illustrating an example of confirmation and correction processing utilizing a confirmation and correction screen according to Embodiment 1;

FIG. 8 is a diagram showing the relationship between FIG. 8A and FIG. 8B;

FIG. 8A is a flowchart describing correction rule construction processing according to Embodiment 1;

FIG. 8B is a flowchart describing correction rule construction processing according to Embodiment 1;

FIG. 9 is a diagram illustrating a screen to present a correction rule description text and accept a direction for a correction rule according to Embodiment 1;

FIG. 10A is a diagram illustrating a screen in a case of processing for updating the correction rule description text according to Embodiment 2;

FIG. 10B is a diagram illustrating a screen in a case of the processing for updating the correction rule description text according to Embodiment 2;

FIG. 11A is a diagram illustrating a screen to present a correction rule candidate and accept multiple directions according to Embodiment 3;

FIG. 11B is a diagram illustrating a screen to present the correction rule candidate and accept the multiple directions according to Embodiment 3; and

FIG. 11C is a diagram illustrating a correction rule details screen according to Embodiment 3.

### DESCRIPTION OF THE EMBODIMENTS

In Japanese Patent Laid-Open No. 2021-163178, a user needs to decipher a description that is highly abstract, such as a regular expression, to confirm whether a constructed correction rule is a correction rule intended by the user; however, it is difficult for the user to properly understand the contents of the correction rule from the description that is highly abstract.

An object of the present disclosure is to make it easy for the user to understand the constructed correction rule.

Hereinafter, embodiments of the present invention are described with reference to the drawings. Note that, the following embodiments are not intended to limit the technique of the present invention according to the scope of claims, and not all the combinations of features described in the present embodiments are necessarily required for the means for solving the problems of the technique of the present disclosure.

### Embodiment 1

A first embodiment of the present invention is described below. First, a system configuration and an overview of an entire processing flow in the present embodiment are described. Subsequently, regarding a configuration according to the present invention, a feature and an effect of the present embodiment are described in detail.

### [System Configuration]

### (Overall Configuration of System)

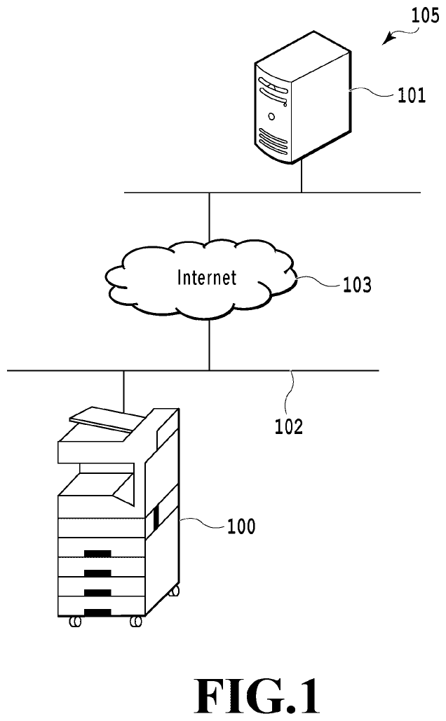

FIG. 1 illustrates an overall configuration of a system to which the present embodiment is applicable. A system 105 of the present embodiment includes an image formation apparatus 100 and a terminal 101. As illustrated in FIG. 1, the image formation apparatus 100 is connected to a LAN 102 and is communicable with the terminal 101 and the like such as a PC via the Internet 103 and the like. Note that, in the present embodiment, the terminal 101 may not be provided, and a configuration including only the image formation apparatus 100 may be applied.

### (Outline of Image Formation Apparatus 100)

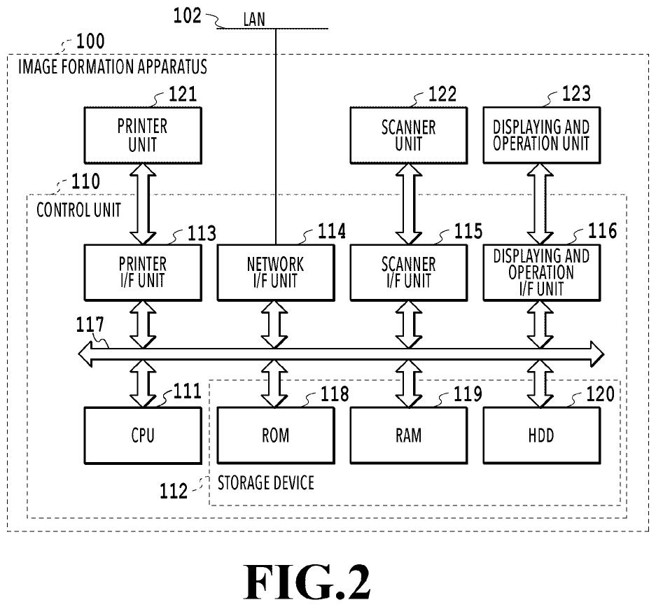

As illustrated in FIG. 2, the image formation apparatus 100 is a multi function peripheral (MFP) including a printer unit 121, a scanner unit 122, a displaying and operation unit 123, and the like. The image formation apparatus 100 can be utilized as a scanning terminal that scans a document manuscript by using the scanner unit 122. Additionally, the displaying and operation unit 123 including a touch panel, a hardware button, and so on is included, and displaying of a presentation result of a file name and a storage destination and displaying of a user interface to accept a direction from a user are performed.

### (Hardware Configuration of Image Formation Apparatus 100)

FIG. 2 illustrates a hardware configuration example of the image formation apparatus 100. The image formation apparatus 100 of the present embodiment includes the printer unit 121, the scanner unit 122, the displaying and operation unit 123, and a control unit 110.

The control unit 110 includes a CPU 111, a storage device 112 (a ROM 118, a RAM 119, an HDD 120), a printer I/F unit 113, a network I/F unit 114, a scanner I/F unit 115, and a displaying and operation I/F unit 116. Additionally, the control unit 110 is an information processing apparatus, in which the above units are communicably connected to each other via a system bus 117, and controls operations of the entire image formation apparatus 100.

The CPU 111 functions as a means that executes each processing such as reading control, image processing, and displaying control in the later-described flowcharts by reading out and executing a control program stored in the storage device 112.

The storage device 112 stores and holds the control program, image data, metadata, setting data, processing result data, and the like. The storage device 112 includes the ROM 118 that is a non-volatile memory, the RAM 119 that is a volatile memory, the HDD 120 that is a large-capacity storage area, and the like. The ROM 118 is a non-volatile memory that holds the control program and the like, and the CPU 111 performs control by reading out the control program. The RAM 119 is a volatile memory used as a temporarily storage area such as a main memory and a working area of the CPU 111.

The network I/F unit 114 connects the control unit 110 (the image formation apparatus 100) to the LAN 102 via the system bus 117. The network I/F unit 114 transmits the image data to an external device on the LAN 102 and receives various types of information from the external device on the LAN 102.

The scanner I/F unit 115 connects the scanner unit 122 and the control unit 110 to each other via the system bus 117. The scanner unit 122 generates scanned image data by reading the document manuscript and inputs the scanned image data to the control unit 110 via the scanner I/F unit 115. Note that, the scanner unit 122 includes a manuscript feeder and can sequentially read multiple manuscripts by feeding the manuscripts put on a tray one by one.

The displaying and operation I/F unit 116 connects the displaying and operation unit 123 and the control unit 110 to each other via the system bus 117. The displaying and operation unit 123 includes a liquid crystal display unit having a touch panel function, a hardware button, and the like.

The printer I/F unit 113 connects the printer unit 121 and the control unit 110 to each other via the system bus 117. The printer unit 121 receives the image data generated by the CPU 111 via the printer I/F unit 113 and performs printing processing on print paper by using the received image data. As above, in the image formation apparatus 100 according to the present embodiment, it is possible to provide a function as an image processing apparatus by the above-described hardware configuration.

### (Functional Configuration of Image Formation Apparatus 100)

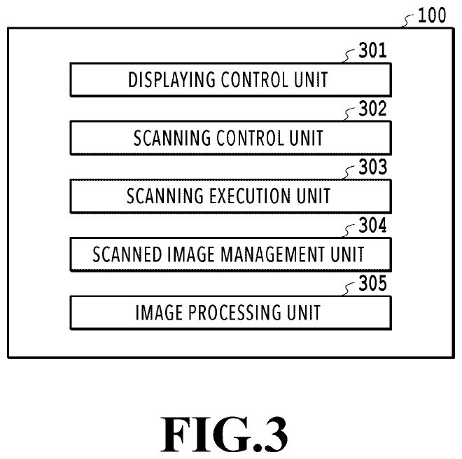

FIG. 3 illustrates a functional configuration example of the image formation apparatus 100 according to the present embodiment. Note that, in FIG. 3, out of functions of the image formation apparatus 100, only functions that are related to processing from scanning and computerization (conversion to a file) of the document manuscript until saving are illustrated.

A displaying control unit 301 displays a user interface screen (UI screen) to accept various user operations on the touch panel of the displaying and operation unit 123. The various user operations include, for example, scanning setting, a scanning start direction, a correction direction for an inputted character string, a direction for a registration method, file name setting, a saving direction for a file, and the like.

A scanning control unit 302 instructs a scanning execution unit 303 to execute scanning processing with information of scanning setting according to the user operation performed on the UI screen (for example, pressing of a “scanning start” button). The scanning execution unit 303 causes the scanner unit 122 to execute a scanning operation of the document manuscript via the scanner I/F unit 115 according to the execution instruction of the scanning processing from the scanning control unit 302 and generates the scanned image data. The generated scanned image data is saved in the HDD 120 by a scanned image management unit 304.

On the scanned image data, an image processing unit 305 performs not only image analysis processing such as character string area detection processing, OCR processing (character recognition processing), and similar document determination processing, but also performs image modification processing including rotation and tilt correction and character string automatic correction processing in accordance with a correction rule described later. With the image processing unit 305, the image formation apparatus 100 also functions as the image processing apparatus. A character string area detected from the scanned image is also referred to as a “text block.” Note that, details of the image processing are described later.

The functions of the units illustrated in FIG. 3 are implemented with the CPU 111 of the image formation apparatus 100 loading the program code stored in the ROM 118 into the RAM 119 to execute. Alternatively, a part of or all the functions of the units in FIG. 3 may be implemented by hardware such as an ASIC and an electronic circuit.

### [Entire Processing Flow]

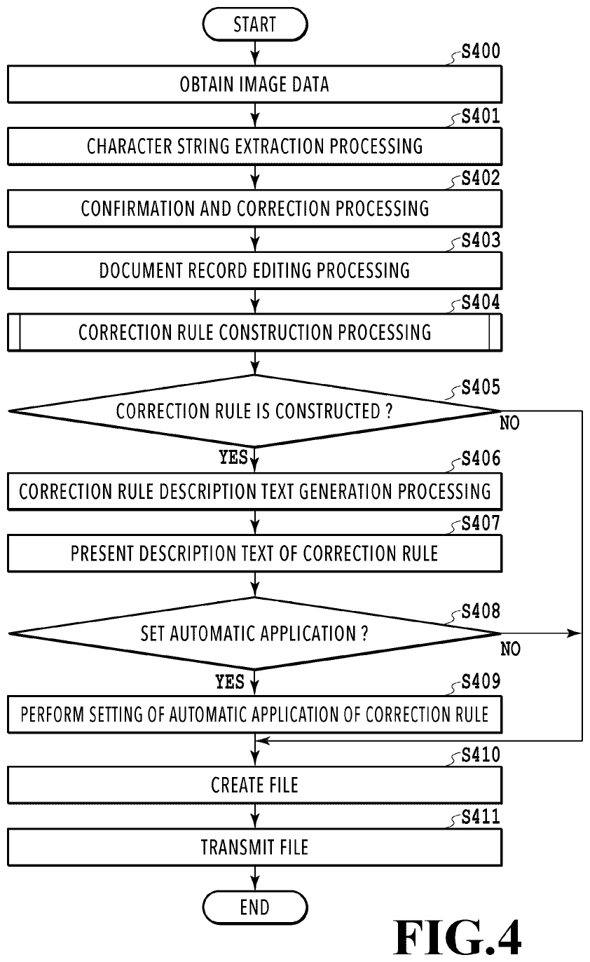

FIG. 4 illustrates a flowchart describing processing executed by the image formation apparatus 100 in the present embodiment. The image formation apparatus 100 scans the document manuscript, performs the image processing on an image obtained as a result of scanning the top page of the document manuscript (hereinafter, referred to as the scanned image), and extracts the character string from the scanned image. An entire processing flow in which the file name is generated by utilizing the obtained character string, the character string is confirmed and corrected, and thereafter the created file is transmitted is described.

A series of processing illustrated in the flowchart in FIG. 4 is performed with the CPU 111 of the image formation apparatus 100 loads the program code stored in the ROM 118 into the RAM 119 to execute. Additionally, a part of or all the functions of steps in FIG. 4 may be implemented by hardware such as an ASIC and an electronic circuit. Note that, a sign “S” in description of each processing means that it is a step in the flowchart, and the same applies to the following flowcharts.

In S400, once the scanning control unit 302 accepts the scanning direction from the user via the displaying and operation unit 123, the scanning control unit 302 allows the scanning execution unit 303 to scan the multiple document manuscripts one by one from the tray of the manuscript feeder of the scanner unit 122. Then, the scanning control unit 302 obtains the scanned image data obtained as a result of scanning.

In S401, the image processing unit 305 analyzes the scanned image data obtained in S400 and performs character string extraction processing. The character string extraction processing includes the image modification processing, the character string area detection processing, the similar document determination processing, the character recognition processing (OCR processing), and the character string automatic correction processing. In the similar document determination processing, processing is performed by using document identification information included in a registered document record described later. In the character recognition processing, processing of character recognition is performed on the detected character string area in accordance with a character string extraction rule included in the later-described registered document record. In the character string automatic correction processing, correction processing of the inputted character string is performed in accordance with the later-described correction rule. Details of the character recognition processing and the character string automatic correction processing, and the document record and the correction rule are described later as a feature of the present embodiment.

The character string extraction rule is one of the pieces of information included in the document record, which is a rule for extracting from the scanned image data the character string of a predetermined item to be utilized as the file name and the metadata, such as a title of the document, a management number, and a company name in the scanned image. The character string extraction rule in the present embodiment is constructed for each document group (hereinafter, referred to as a similar document group) that is determined by the image processing unit 305 as similar documents by the above-described similar document determination processing. In addition, the character string extraction rule is used to generate the file name in a case of saving the scanned image data, and a correction rule for each extraction target item and a file name rule defining the sorting order of the extraction target items and the like are set. Note that, the character string extraction rule is not limited to be used for the generation of the file name and may also be used for setting of other property information such as extraction of the metadata and generation of a folder path. That is, the character string extraction rule is a rule for extracting information that is set as a property (attribute) related to the scanned image data from the scanned image data, and one of the pieces of information set by using the character string extraction rule is the file name.

The correction rule is a rule defining a correction method of the character string in a case where correction is set to the character string that is recognized as a character in the character string area determined as an extraction target based on the character string extraction rule, and the correction rule is constructed by correction rule construction processing described later. The correction of the character string in the present embodiment is processing of performing a correction operation one or more times, such that a partial character string matching a regular expression or character string representing a correction target set by the correction rule matches a post-correction regular expression or character string that is set. The individual corrections included in the correction rule include “correction of a similar glyph,” “changing of the number of digits of a numeric character string,” “changing (deleting, converting, adding) of a common noun,” and “changing (deleting, converting, adding) of a separation character.” An application range of the correction rule in the present embodiment is set in the unit of the extraction target item, to which the character string extraction rule constructed for each similar document group in the documents utilized by all the users of the same image formation apparatus 100 is applied. Note that, the application range of the correction rule may be, for example, all the extraction target items of the similar document group, a specific extraction target item of all the documents utilized by the same user, a specific document group that is utilized by the image formation apparatuses connected to the same LAN 102, or the like.

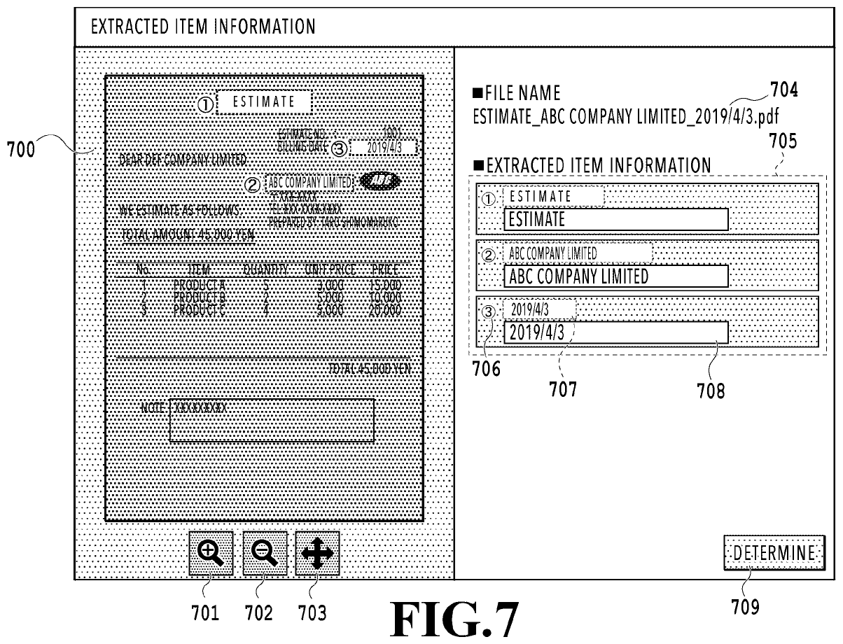

In S402, the displaying control unit 301 generates the file name of the scanned image data by using the character string extracted in S401 and displays a confirmation and correction screen including the character string and the generated file name on the displaying and operation unit 123 to present the confirmation and correction screen to the user. Additionally, the displaying control unit 301 accepts confirmation or correction of the presented character string by the user. Once the displaying control unit 301 accepts confirmation or correction from the user via the displaying and operation unit 123, the displaying control unit 301 sets the presented file name, or the file name after correction in a case where the character string is corrected, as the file name of the scanned image data. Details of confirmation and correction processing are described later with reference to FIG. 7 as a feature of the present embodiment.

In S403, the image processing unit 305 determines whether the user corrects the character string in S402, and if the user performs correction of the character string, updating of the character string extraction rule of the document and processing of newly registering the document (document registration processing) are performed. Details of the updating of the character string extraction rule and the document registration processing are described later in the description of the confirmation and correction processing as a feature of the present embodiment.

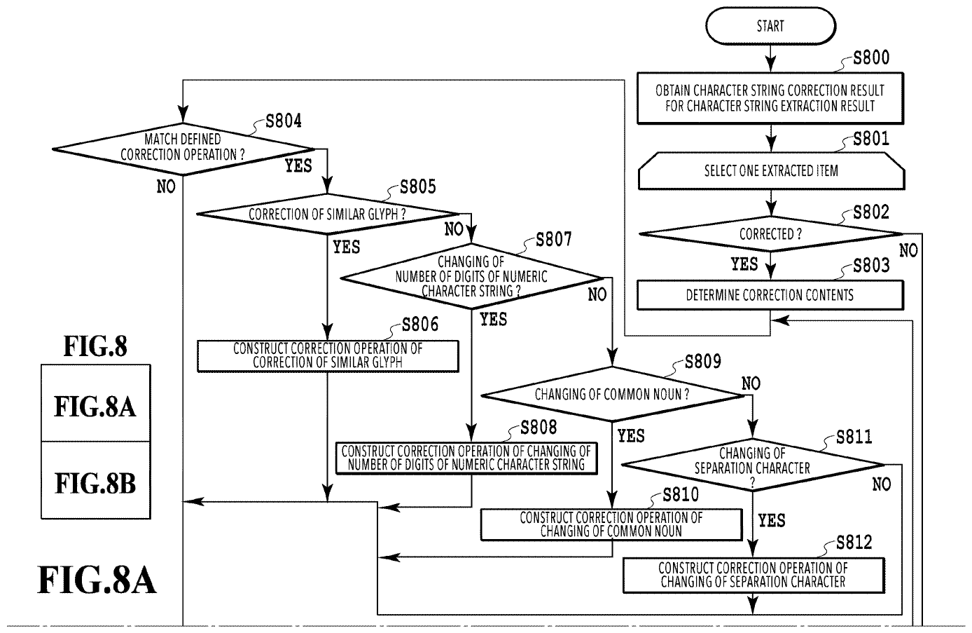

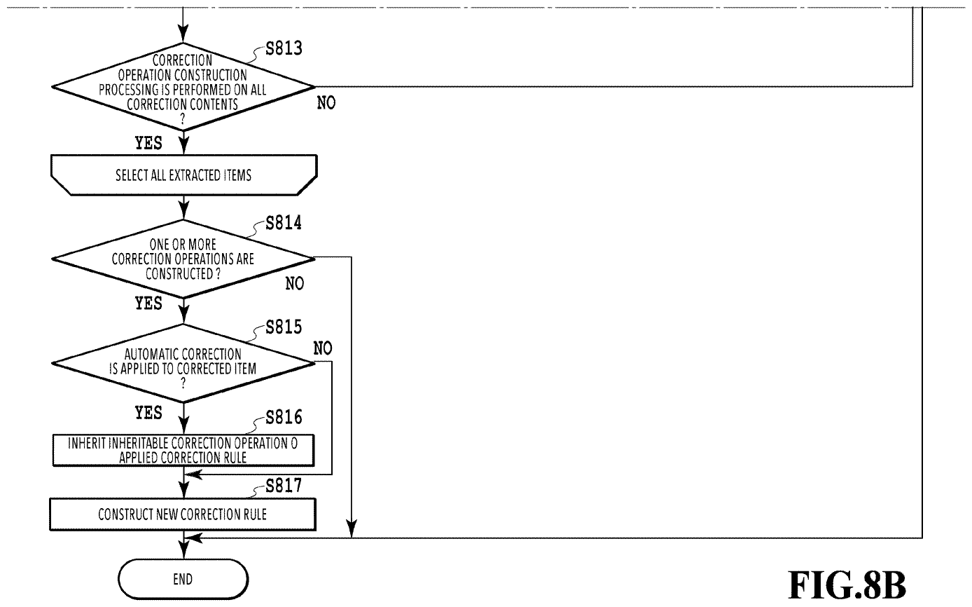

In S404, the image processing unit 305 determines whether the user corrects the character string via the displaying and operation unit 123 in S402, and if the user performs correction of the character string, processing of constructing the correction rule (correction rule construction processing) is performed. Details of the correction rule construction processing are described later with reference to FIGS. 8A and 8B as a feature of the present embodiment.

In S405, the image processing unit 305 determines whether the correction rule is constructed in S404. If the image processing unit 305 does not construct the correction rule, the processing proceeds to S410, and if the image processing unit 305 constructs the correction rule, the processing proceeds to S406.

In S406, the image processing unit 305 performs processing of generating a description text of the correction rule constructed in S404 (correction rule description text generation processing). Details of the correction rule description text generation processing are described later as a feature of the present embodiment.

In S407, the displaying control unit 301 displays the description text of the correction rule generated in S406 on the displaying and operation unit 123 to present the description text to the user.

In S408, the displaying control unit 301 accepts a user direction for the correction rule. Here, the user direction for the correction rule in the present embodiment is a direction “to automatically apply the correction rule” and a direction “not to automatically apply the correction rule.” The presentation of the description text of the correction rule and the acceptance of the user direction for the correction rule are described later as a feature of the present embodiment. If the displaying control unit 301 accepts the direction “not to automatically apply the correction rule,” the processing proceeds to S410. If the displaying control unit 301 accepts the direction “to automatically apply the correction rule” (it is to automatically apply in S408), the processing proceeds to S409.

In S409, the image processing unit 305 sets the automatic application of the correction rule. As described above, the automatic application range of the correction rule in the present embodiment is for each extraction target item of the character string extraction rule constructed for each similar document group in the documents utilized by all the users of the same image formation apparatus 100. Therefore, as a target of the character string automatic correction of each correction rule, each extraction target item is set based on the character string extraction rule held in the document record of each similar document group. Details are described as a part of the later-described correction rule construction processing.

In S410, the image processing unit 305 creates the file from the scanned image data obtained in S400 and sets the file name determined in S402. In the present embodiment, as an example, it is described assuming that the scanned image data is saved by converting the data into a Portable Document Format (PDF) as a file format. In a case of the PDF, if multiple paper manuscripts are scanned in S400, the scanned image data corresponding to each paper manuscript is saved as individual pages in one file.

In S411, the scanned image management unit 304 transmits the file created in S410 to a predetermined transmission destination through the LAN 102.

### Feature of Embodiment 1

The character recognition processing, the character string automatic correction processing, the confirmation and correction processing, the correction rule construction processing, the correction rule description text generation processing, and the presentation of the description text of the correction rule and the acceptance of the direction for the correction rule, which are features of the present embodiment, are described in detail with reference to the drawings.

### (Character Recognition Processing)

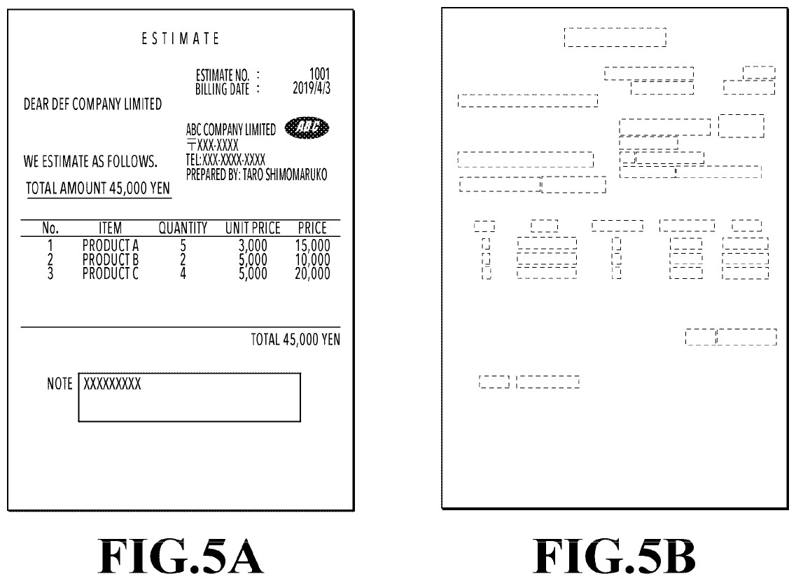

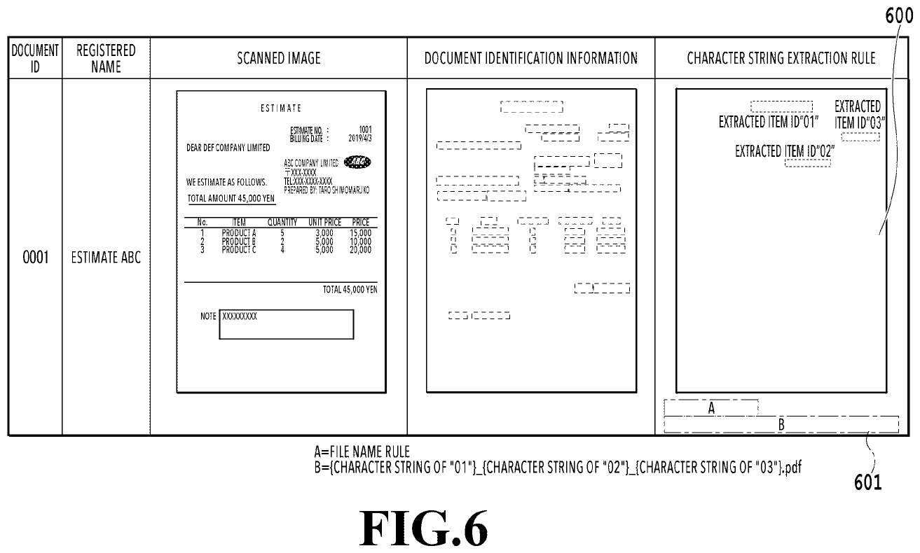

Details of the character recognition processing, which is internal processing of the character string extraction processing (S401), are described with reference to FIGS. 5A and 5B, FIG. 6, and Table 1.

FIGS. 5A and 5B illustrate an example of a result of the character string area detection processing, which is internal processing of the character string extraction processing (S401), in the present embodiment. FIG. 5A is the scanned image after the image modification processing, which is internal processing of the character string extraction processing (S401). FIG. 5B is a result of the character string area detection processing performed on the scanned image in FIG. 5A, in which a foreground area detected as the character string area is represented by a rectangle indicated by a broken line. The character string area in FIG. 5B is used in the similar document determination processing and the character recognition processing, which are internal processing of the character string extraction processing (S401).

FIG. 6 illustrates an example of the registered document record in the present embodiment. This is the registered document record used in a case of performing the similar document determination processing using the character string area in FIG. 5B. Each document record includes information of “document ID,” “registered name,” “scanned image,” “document identification information,” and “character string extraction rule.”

“Document ID” is a unique identification number allocated for each similar document group in a case of the document record registration.

“Registered name” is a name set in a case of the document registration, and “scanned image” is the scanned image data in a case of the document record registration. Those are the information used by the user to identify the registered document. Note that, as long as “scanned image” holds information that allows the user to identify the feature of the document, the resolution may be reduced to about 150 dpi, for example.

“Document identification information” is information used to identify the document record in which the scanned image data similar to the scanned image data obtained by the image processing unit 305 in S400 is registered. Specifically, “document identification information” is information of a position and a size of the character string area obtained as a result of executing the character string area detection processing on the scanned image data. Note that, as long as “document identification information” is the information required to identify the document record in which the scanned image data similar to the scanned image data obtained in S400 is registered, it is not limited to the information of the position and the size of the character string area. For example, a position and a shape of a ruled line included in the document may be held, or a combination of the character strings that appear in the document may be utilized.

“Character string extraction rule” is information used to generate the file name from the scanned image data, which includes an extracted item ID, which is an identification number for each extracted item, the order of application to the file name for each extracted item ID, and information of a coordinate and a size of the character string area for each extracted item ID. An image 600 is an illustration in which the information of the coordinate and the size of the character string area for each extracted item ID is arranged, with the extracted item ID, at a coordinate corresponding to the scanned image. A file name rule 601 included in “character string extraction rule” in FIG. 6 indicates a generation rule of the file name using the character string that is recognized as a character in the character string area corresponding to the extracted item ID. As illustrated in FIG. 6, the file name rule 601 is a rule that the character strings that are recognized as characters in the character string areas corresponding to the extracted item IDs “01,” “02,” and “03” are coupled in this order by using underscores.

As described above, as for the scanned image data illustrated in FIG. 5A, the similar document determination processing is performed on each registered document record by using the information of the position and the size of the character string area illustrated in FIG. 5B. In the similar document determination processing, the overlap between the character string area in the scanned image data obtained in S400 and the character string area registered as the document identification information included in each registered document record is calculated as a similarity level. In addition, in a case where the similarity level is equal to or greater than a predetermined value, it is determined that the scanned image data is a similar document of the registered document record that has the highest similarity level. Note that, in a case where there is no registered document record that has the similarity level equal to or greater than the predetermined value, it is determined that there is no similar document. There is the following method as an example of a method of calculating the similarity level. First, positioning is performed between the entire character string area in the scanned image data obtained in S400 and the entire character string area of each registered document record, and the square (value A) of the sum of overlapping areas between the character string area in the scanned image data and the character string area of each registered document record is obtained. In addition, the multiplication (value B) of the sum of the areas of the character string areas in the scanned image data obtained in S400 and the sum of the areas of the character string areas of each registered document record is obtained. Then, the similarity level is a value obtained by dividing the value A by the value B.

In the present embodiment, in a case where the scanned image data is determined as the similar document of a document registered in the document record of a document ID “0001,” the document ID “0001” is applied to the scanned image data. Then, the item as the extraction target is detected from the scanned image data according to the character string extraction rule illustrated in FIG. 6, and the character recognition processing is performed. Here, for instance, in a case it is determined that the scanned image data in FIG. 5A is not the similar document of the document registered in the registered document record, a new document record is generated and registered based on the scanned image data. In the new document record, a unique identification number different from an already-existing document ID is applied as the document ID, the scanned image in FIG. 5A is registered as the scanned image, and the character string area in FIG. 5B is registered as the document identification information. Additionally, the displaying control unit 301 accepts a user input regarding the character string area in which the character string used for the file name is arranged or the extracted item ID corresponding to the character string area and the file name rule defining the order and the like, and the registered name. Thus, the registered name and the character string extraction rule are registered in the new document record.

In order to estimate the character string area as the character recognition processing target in the scanned image data in FIG. 5A, target character string area estimation processing is performed as pre-processing of the character recognition processing. The target character string area estimation processing is processing of estimating the character string area in the scanned image data that has a large overlap with the character string area indicated in the image 600 of “character string extraction rule” in FIG. 6. The target character string area estimation processing also includes processing of performing the entire positioning between the scanned image of the registered document record and the scanned image in FIG. 5A. Note that, the method of estimating the character string area as the character recognition processing target is not limited to the above. For example, as for the character string area registered as the character string extraction rule, a surrounding character string area is extracted as a partial pattern from a character string area group in the document registered in the document record. Then, estimation may be performed by using the extracted partial pattern to perform local positioning by executing pattern matching, within a search area set in advance, with respect to the character string area in the inputted document after the entire positioning.

Table 1 illustrates a result obtained with the image processing unit 305 recognizing the character string corresponding to each character string area by executing partial optical character recognition (OCR) on the character string area group as the character recognition processing target in the scanned image in FIG. 5A, which is estimated by the above-described target character string area estimation processing. As illustrated in Table 1, as for the scanned image in FIG. 5A, “ESTIMATE” (with spaces in-between) is recognized as the character string of the extracted item ID “01,” “ABC company limited” is recognized as the character string of the extracted item ID “02,” and “2019/04/03” is recognized as the character string of the extracted item ID “03.”

TABLE 1

| | extracted | character string |
|---|---|---|
| document ID | item ID | recognition result |
| 0001 | 01 | E S T I M A T E |
| | 02 | ABC company limited |
| | 03 | 2019 Apr. 3 |

### Character String Automatic Correction Processing

Details of the character string automatic correction processing, which is internal processing of the character string extraction processing (S401), are described with reference to Table 2.

Table 2 is a table illustrating an example of the correction rule and illustrates an example of performing the character string automatic correction processing on the character string recognition result of the document of the document ID “0001” illustrated in Table 1. In the correction rule, “correction rule ID” and “correction target ID” are associated with each other in the unit of correction rule. Additionally, the correction rule may be divisible into the unit of multiple corrections, and correction is performed by the correction operation for each unit of correction such that the partial character string as the correction target matches the regular expression or the character string of the post-correction partial character string. In a case where one character string includes multiple partial character strings as the correction target, the correction operation is executed for the character string multiple times.

The correction rule ID is an identification number unique for each correction rule. The correction target ID is an identification number associated with the target character string area to which the automatic application of the correction rule is set. The correction target ID in the present embodiment is expressed in the form coupling the document ID and the extracted item ID as the target by an underscore. Note that, there is also a case where one correction rule is applied to multiple character string areas, and therefore there is also a case where multiple correction target IDs are associated with one correction rule ID.

TABLE 2

| | | | partial | post- |
|---|---|---|---|---|
| | | | character | correction |
| | | correction | string as | partial |
| correction | correction | operation | correction | character |
| rule ID | target ID | number | target | string |
| 1 | 0001_01 | 1 | ¥s | (no character) |
| | 0001_03 | | | |
| 2 | 0001_02 | 1 | Co., Ltd. | company |
| | | | | limited |
| | | 2 | ¥s | (no character) |

In Table 2, as the correction rule targeting the document of the document ID “0001,” the correction rule of a correction rule ID “1” targeting the extracted item IDs “01” and “03” and the correction rule of a correction rule ID “2” targeting the extracted item ID “02” are registered.

The correction rule of the correction rule ID “1” is a rule that the partial character string as the correction target adapting to a regular expression “¥s” (blank character) with the correction operation number “1” is corrected to a post-correction partial character string “ ” (no character).

The correction rule of the correction rule ID “2” corrects the partial character string as the correction target adapting to a special character “Co., Ltd.” with the correction operation number “1” to a post-correction partial character string “company limited”. Subsequently, this is a rule that the partial character string as the correction target adapting to the regular expression “¥s” (blank character) in the correction operation number “2” is corrected to the partial character string “ ” (no character) after correction.

The character string of the extracted item ID “01” is the target of the correction rule automatic application setting of the correction rule ID “1.” With reference to Table 1, the extracted character string is “ESTIMATE” (including spaces), and seven spaces respectively located between “E” and “S,” “S” and “T,” “T” and “I,” “I” and “M,” “M” and “A,” “A” and “T” “T” and “E” adapts to the partial character string as the correction target of the correction operation number “1.” Therefore, the seven spaces are automatically corrected to no character. As a result, the character string of the extracted item ID “01” is corrected to “ESTIMATE”, with no space between the characters.

The character string of the extracted item ID “02” is the target of the correction rule automatic application setting of the correction rule ID “2.” However, with reference to Table 1, since the extracted character string is “ABC company limited,” the character string does not adapt to the partial character string as the correction target, and the character string maintains “ABC company limited.”

The character string of the extracted item ID “03” is the target of the correction rule automatic application setting of the correction rule ID “1.” However, with reference to Table 1, since the extracted character string is “2019/04/03,” the character string does not adapt to the partial character string as the correction target, and the character string maintains “2019/04/03.”

### (Confirmation and Correction Processing)

Details of the confirmation and correction processing (S402) are described with reference to FIG. 7.

FIG. 7 illustrates a confirmation and correction screen displayed on the displaying and operation unit 123 in a case where the document record in which the scanned image data having the similarity level equal to or greater than a predetermined value with the scanned image data obtained in S400 is registered is identified, and the character string is extracted in the character string extraction processing (S401).

In a preview area 700, the scanned image data obtained in S400 is displayed as a preview image. Additionally, a rectangle indicating the position of the estimated character string area is highlighted on the scanned image. Buttons 701 and 702 are buttons that allow enlarging and reducing the display magnification of the preview image. A button 703 is a button that allows enlarging or reducing the preview image to fit the width or the height of the preview area. In a file name text field 704, according to the character string extraction rule set in advance, the file name generated by combining the character strings extracted in S401 is displayed. In an extracted item information area 705, an extracted item number area 706, a partial preview area 707, and an extracted item text field 708 of each extracted item are displayed. In the extracted item number area 706, a number representing the extracted item ID is displayed. In the partial preview area 707, an image partially cut out of the scanned image corresponding to the estimated character string area is displayed. In the extracted item text field 708, a character string extraction result of the character string area is displayed, and in a case where the character string extraction result is incorrect, the user can edit the character string.

As for the character string in the character string area where the estimation fails, in the extracted item information area 705, the number representing the extracted item ID is displayed in the extracted item number area 706, but the partial preview area 707 and the extracted item text field 708 are displayed in a blank state.

A character string area correction procedure in a case where the position of the character string area estimated in S401 is incorrect, or in a case where the estimation of the character string area fails is described. In a case where correction of an already-existing extracted item is performed, first, the user selects one of the extracted items displayed in the extracted item information area 705 that corresponds to the character string that the user wants to correct. Subsequently, the correct position of the character string area on the preview area 700 is designated. Then, the partial preview area 707 is updated according to the character string area designated by the user, the character string on which the character recognition processing and the character string automatic correction processing are performed is newly displayed in the extracted item text field 708, and the file name text field 704 is updated. Additionally, in a case where the user wants to add the extracted item, the user can add the extracted item by designating the position of the character string area on the preview area 700 in a state without selecting the extracted item information area 705. In this case, the new extracted item is newly added to the extracted item information area 705, and an image corresponding to the character string area designated by the user is displayed in the partial preview area 707. Then, the character string on which the character recognition processing and the character string automatic correction processing are performed is displayed in the extracted item text field 708, and the file name text field 704 is updated.

Next, a character string correction procedure in a case where the position of the character string area estimated in S401 is correct, but the extracted character string is incorrect or the user wants to correct the description is described. First, the user selects the extracted item text field 708 in which the character string that the user wants to correct is displayed. Subsequently, the user performs a cursor operation and an operation of inputting and deleting of the character string on the extracted item text field 708 by using a software keyboard and the like overlayed and displayed on the displaying and operation unit 123. Then, once the character string on the extracted item text field 708 is corrected by the operation accepted by the displaying and operation unit 123, the file name text field 704 is updated. Note that, if it is determined in S401 that there is no corresponding registered document record, the extracted items of all the character strings are displayed in the extracted item information area 705. In this case, as with a case of failing the estimation of the character string area described above, the partial preview area 707 and the extracted item text field 708 of each extracted item are displayed in a blank state. Additionally, according to the above-described character string area correction procedure, it is also possible to newly designate the position of each character string area.

In a case where the user completes the confirmation and the correction and presses a determination button 709, the file name and the character string and the character string area for each extracted item ID are settled. Here, in a case where the character string area correction, the item addition, and the item deletion are performed, the character string extraction rule in the document record is updated depending on the contents. Additionally, if it is determined in S401 that there is no corresponding registered document record, the new document record to which the new document ID is allocated is generated, and the registered name of the generated new document record is accepted from the user via the displaying and operation unit 123 and determined. Then, the scanned image as illustrated in FIG. 5A and the character string area as illustrated in FIG. 5B are registered as the scanned image data and the document identification information, and the extracted item ID and the character string area that are added as the new item are registered as the character string extraction rule.

### (Correction Rule Construction Processing)

Details of the correction rule construction processing (S404) are described with reference to FIGS. 8A, 8B and Table 3.

FIGS. 8A and 8B illustrate a flowchart describing the correction rule construction processing executed on the character string of each extracted item in the present embodiment. Note that, the correction rule in the present embodiment targets the correction of the character string itself and does not target the positional correction of the character string area.

In S800, the image processing unit 305 obtains the result obtained in the character string extraction processing (S401) and the result settled in the confirmation and correction processing (S402). In the present embodiment, information of the obtained result is the character string for each extracted item ID obtained as a result of the character string extraction processing and the character string for each settled extracted item ID; however, for example, an input operation by the user such as a key operation in a case of correction may be obtained directly. Note that, in the confirmation and correction processing (S402), in a case where the above-described character string area correction is performed, the character string obtained by the character recognition processing and the character string automatic correction processing performed after the correction of the character string area is obtained as the character string for each extracted item ID obtained as a result of the character string extraction processing.

In S801, the image processing unit 305 selects one of the extracted items obtained as a result of the character string extraction processing obtained in S800.

In S802, the image processing unit 305 determines whether the character string correction by the user is performed on the character string of the extracted item selected in S801. If the image processing unit 305 determines that the character string correction by the user is not performed, the correction rule construction processing for the character string of the extracted item ends. If the image processing unit 305 determines that the correction by the user is performed, the processing proceeds to S803. As the determination method, if the character string obtained as a result of the character string extraction processing and the settled character string mismatch between the same extracted item IDs, it is determined that the character string correction is performed, and in other cases, it is determined that the character string correction is not performed.

In S803, the image processing unit 305 determines the correction contents for each extracted item on which it is determined in S802 that the character string correction is performed. Here, in the present embodiment, individual correction operations that are the determination target and included in the constructed correction rule are “correction of a similar glyph,” “changing of the number of digits of a numeric character string,” “changing (deleting, converting, adding) of a common noun,” and “changing (deleting, converting, adding) of a separation character.” Note that, the correction operation included in the correction rule is not limited thereto and, for example, corrections for various use applications may be included, such as “changing between one-byte and two-byte,” “conversion of calendar,” and “changing of the display order of date.” Additionally, there is also a case where multiple corrections are included in the correction contents for each extracted item; for this reason, the processing is repeated until determining all the above-described corrections for each extracted item. The priority rank of the correction as the determination target in a case of determining the correction contents in the present embodiment is “correction of a similar glyph,” “changing of the number of digits of a numeric character string,” “changing (deleting, converting, adding) of a common noun,” and “changing (deleting, converting, adding) of a separation character” in descending order.

A method of determining whether the above-described correction is included in the correction contents in the present embodiment is described below.

The determination of whether it is “correction of a similar glyph” is performed based on whether the post-correction partial character string in a corrected portion is a similar glyph of a pre-correction partial character string. Here, the similar glyph is a character string that is frequently mistaken for the correct character string while performing the character recognition because the glyph is similar, and the similar glyph is managed by a similar glyph dictionary. The similar glyph dictionary is a dictionary in which a similar glyph character string group with respect to a predefined character string is registered. For example, “1” is registered as the similar glyph character string of “i,” and “i” is registered as the similar glyph character string of “1.” Thus, usually the character strings are registered as the similar glyph character strings bi-directionally. Additionally, there is also a case where not only between the characters but also the character string is registered as a similar glyph, like “modem” is registered as the similar glyph character string of “modern.” Moreover, there is also a case where multiple similar glyph character strings are registered with respect to one character string, like “3” and “B” are registered as the similar glyph of “8.”

The determination of whether it is “changing (deleting, converting, adding) of a common noun” is performed based on whether the partial character string that is deleted, converted, or added before and after correction matches a common noun. Here, the common noun is a noun other than a proper noun and is managed by a common noun dictionary. As an example of the common noun managed by the common noun dictionary, there are “company limited,” “stock,” “limited private company,” “company,” “estimate,” “quotation,” “bill,” “billing,” “issue date,” “issuance,” “date,” “western calendar,” and the like. In addition, there are also “phone number,” “address,” “zip code,” “name,” “full name,” and the like.

The determination of whether it is “changing (deleting, converting, adding) of a separation character” is performed based on whether the character that is deleted, converted, or added before and after correction matches a separation character. Here, the separation character is a character separating the character string and is managed by the separation character dictionary. As an example of the separation character managed by the separation character dictionary, there are “_,” “/,” “,,” “.,” “-,” “(space),” “year,” “month,” “day,” and the like.

The determination of whether it is “changing of the number of digits of a numeric character string” is performed based on whether the displayed number of digits of a character string, which includes only numbers and is separated by a character string formed of a character other than a number, is changed. For example, in a case where “2023/1/14” is corrected to “2023/01/14,” out of “2023,” “/,” “1,” “/,” and “14,” the displayed number of digits of the partial character string including only a number “1” is changed to “01” representing the same numerical value. Therefore, in this case, it is determined as changing of the number of digits of a numeric character string. However, in a case like “2023 Oct. 14” in which “1” is changed to a different numerical value “10,” it is not determined as changing of the number of digits of a numeric character string.

In S804, if there is the defined correction operation matching the correction contents, the image processing unit 305 allows the processing to proceed to S805, and if there is no matching correction operation, the processing proceeds to S813.

In S805, if it is determined that the correction operation matching the correction contents is “correction of a similar glyph,” the image processing unit 305 allows the processing to proceed to S806, and if it is determined that the correction operation is not “correction of a similar glyph,” the processing proceeds to S807.

In S806, the image processing unit 305 constructs the correction operation of the similar glyph correction. In the correction operation of the similar glyph correction, for example, in a case where “estimate” is mistakenly character-recognized as “estimate,” the user corrects “estimate” to “estimate.” In this case, “I” that is registered in the dictionary as the similar glyph of “i” is automatically corrected to “i,” “estImate” is set as the partial character string as the correction target, and “estimate” is set as the post-correction partial character string. There is a possibility that the character mistake between the similar glyphs occurs bi-directionally; for this reason, the correction operation is limited to the correction of the character string having a certain number of characters, instead of the correction of a character, and the post-correction character string is assumed as a correct word. Thus, the bi-directional mistake between the similar glyphs is suppressed. Additionally, since a number has a high possibility of the bi-directional mistake also in a case of the character string, it is not the target of the automatic correction of a similar glyph.

In S807, if it is determined that the correction operation matching the correction contents is “changing of the number of digits of a numeric character string,” the image processing unit 305 allows the processing to proceed to S808, and if it is determined that the correction operation is not “changing of the number of digits of a numeric character string,” the processing proceeds to S809.

In S808, the image processing unit 305 constructs the correction operation of the changing of the number of digits of a numeric character string. In the following, as an example, the correction operation constructed in a case where the user corrects “2019/04/03” to “2019/04/03” is described. First, “¥d{1,4}¥D+¥d{1,2}¥D+¥d{1,2}” (a number of one to four digits, a number of one to two digits, and a number of one to two digits are separated by a character string of one or more characters formed of a character other than a number) is set as the partial character string as the correction target by using the regular expression. Subsequently, “¥d{04}¥D+¥d{02}¥D+¥d{02}” (a number of four digits, a number of two digits, and a number of two digits that are zero-padded are separated by a character string of one or more characters formed of a character other than a number) is set as the post-correction partial character string by using the regular expression.

It should be note that, actually, multiple types of processing as follows are performed on the three portions of number portions described above, which are “2019,” “4,” and “3.” First, replacement is performed such that 0 for the designated number of digits is applied to the beginning, like “0000 ¥d,” “00 ¥d,” and “00¥d,” correspondingly. Subsequently, “0*¥d” is replaced to “¥d{4},” “0*¥d” is replaced to “¥d{2},” and “0*¥d” is replaced to “¥d{2}” again, correspondingly, and thus processing of obtaining zero-padded numbers for the designated number of digits is performed. For the sake of convenience, in the present embodiment, the multiple correction operations is expressed as one correction operation by the above-described regular expression.

Note that, in the above-described example, although the number of digits in the portion of “2019/” is not changed, since the correction of the changing of the number of digits (number of digits fixation) is performed on another numerical value within the item, the correction operation to fix the number of digits for all the numerical values within the item is constructed.

Additionally, for example, there is also a possibility that the user corrects “2019/04/03” to “2019/04/03.” In this case, unlike the above-described example, first, “¥d{4}¥D+¥d{2}¥D+¥d{2}” (a number of four digits, a number of two digits, and a number of two digits are separated by a character string of one or more characters formed of a character other than a number) is set as the partial character string as the correction target by using the regular expression. Subsequently, “¥d{1,4}¥D+¥d{1,2}¥D+¥d{1,2}” (a number of one to four digits, a number of one to two digits, and a number of one to two digits are separated by a character string of one or more characters formed of a character other than a number) is set as the post-correction partial character string by using the regular expression.

In S809, if it is determined that the correction operation matching the correction contents is “changing (deleting, converting, adding) of a common noun,” the image processing unit 305 allows the processing to proceed to S810, and if it is determined that the correction operation is not “changing (deleting, converting, adding) of a common noun,” the processing proceeds to S811.

In S810, the image processing unit 305 constructs the correction operation of the changing of a common noun. The correction operation of the changing of a common noun is, for example, in a case where the user corrects “ABC Co., Ltd.” to “ABC company limited,” “Co., Ltd.” is set as the partial character string as the correction target, and “company limited” is set as the post-correction partial character string by using “Co., Ltd.” and “company limited” registered in the common noun dictionary. In addition, there is also a case where the correction operation of newly adding the character string registered in the common noun dictionary to the beginning or the end of the character string or in front of or after a specific character string, and the correction operation of deleting the common noun are constructed. Although it is not performed in the present embodiment, words in the common noun dictionary may be associated with each other as synonymous words, and the conversion of the common noun may be performed only between the synonymous words.

In S811, if it is determined that the correction operation matching the correction contents is “changing (deleting, converting, adding) of a separation character,” the image processing unit 305 allows the processing to proceed to S812, and if it is determined that the correction operation is not “changing (deleting, converting, adding) of a separation character,” the processing proceeds to S813.

In S812, the image processing unit 305 constructs the correction operation of the changing of a separation character. In the constructed correction operation, for example, in a case where the user corrects “03-0000-0000” to “0300000000,” “-” is set as the partial character string as the correction target by using “-” registered in the separation character dictionary. Additionally, “ ” (no character) is set as the post-correction partial character string. Moreover, the correction operation constructed in a case where the user corrects “2019/04/03” to “2019.04.03” is described below as an example. First, “/” and “.” registered in the separation character dictionary are used to set “[/]” as the partial character string as the correction target by using the regular expression, and “¥.” (dot) is set as the post-correction partial character string by using the regular expression.

After S806, S808, S810, and S812 are executed, the processing proceeds to S813.

In S813, the image processing unit 305 determines whether the correction operation construction processing is performed on all the correction contents determined in S801 to S812. If the correction operation construction processing is not performed on all the correction contents, the processing returns to S804. If the correction operation construction processing is performed on all the correction contents, the processing proceeds to S814.

In S814, the image processing unit 305 determines whether one or more correction operations are constructed. If one or more correction operations are not constructed, the correction rule construction processing for the character string of the extracted item ends. If one or more correction operations are constructed, the processing proceeds to S815.

In S815, the image processing unit 305 determines whether the correction rule is already automatically applied to the character string of the extracted item for each extracted item for which one or more correction operations are constructed. If the correction rule is not automatically applied, the processing proceeds to S817, and if the correction rule is already automatically applied, the processing proceeds to S816.

In S816, the image processing unit 305 inherits an inheritable correction operation out of the correction operations included in the automatically applied correction rule. Here, the inheritable correction operation is a correction operation that does not correspond to the partial character string as the correction target, out of the correction operations corresponding to the corrected partial character string included in the automatically applied correction rule, out of the character string correction results by the user obtained in S800. For example, a case where “2019/04/03” is extracted under the correction rule of only the correction operation to correct the partial character string as the correction target “¥s” (blank character) to the post-correction partial character string “ ” (no character) is described. First, the character string is automatically corrected to “2019/04/03” by the above-described correction rule. Subsequently, for example, in a case where the user corrects “2019 4 3” (a space as the separation character), since the space newly inserted by the user matches the partial character string as the correction target that is the deletion target, this correction operation is the correction operation that is not inheritable.

In S817, the image processing unit 305 constructs a new correction rule by using all the constructed correction operations and the correction operation inherited in S816. In this case, integration of correction operations of equal post-correction partial character strings is performed. Specifically, in the correction operation of the changing of a separation character, integration of separation characters set as the partial character string as the correction target is performed, and in a case where a defined number or more of the separation characters are set, all the separation characters are set as the partial character string as the correction target. Additionally, all the constructed correction operations and all the correction operations inherited in S816 are sorted based on the priority rank of the correction contents described above. Moreover, a new correction rule ID is allocated to the constructed new correction rule.

In contrast to Table 2, Table 3 illustrates an example in which the correction rule that is constructed in a case where the user corrects the extracted character string “2019/04/03” of the extracted item ID “03” of the scanned image in FIG. 5A to “20190403” is added.

Note that, although the correction rule of the new correction rule ID “3” is constructed and registered by the above-described correction rule construction processing (S404), whether to set as the automatic application target is determined based on the direction accepted in S408. Therefore, in Table 3, it is a state in which no correction target ID is set.

TABLE 3

| | | | partial | post- |
|---|---|---|---|---|
| | | | character | correction |
| | | correction | string as | partial |
| correction | correction | operation | correction | character |
| rule ID | target ID | number | target | string |
| 1 | 0001_01 | 1 | ¥s | (no character) |
| | 0001_03 | | | |
| 2 | 0001_02 | 1 | Co., Ltd. | company limited |
| | | 2 | ¥s | (no character) |
| 3 | (none) | 1 | ¥d{1,4}¥D + | ¥d{04}¥D + |
| | | | ¥d{1,2}¥D + | ¥d{02}¥D + |
| | | | ¥d{1,2} | ¥d{02} |
| | | 2 | [¥s/] | (no character) |

### Correction Rule Description Text Generation Processing

Details of the correction rule description text generation processing (S406) are described with reference to Table 4.

Table 4 is a table illustrating a predefined sentence of the description text, and in the present embodiment, the predefined sentence corresponding to each correction operation constructed by the correction rule construction processing (S404) is stored in the storage device 112 of the image formation apparatus 100 such as the ROM 118.

TABLE 4

| correction contents | predefined sentence of description text |
|---|---|
| correction of a | correct “{a character string including a |
| similar glyph | similar glyph before correction}” [in a |
| | character string\|] to “{a character string |
| | including a similar glyph after |
| | correction}” [.\|, and] |
| changing of the number | convert a number (in a character string\|) |
| of digits of a numeric | into “{number of digits}” digits [, |
| character string | “{number of digits}” digits] (.\|, and) |
| deletion of a | delete “{common noun before |
| common noun | correction}” (in a character string\|) (.\|, |
| | and) |
| conversion of a | convert “{common noun before |
| common noun | correction}” (in a character string\|) into |
| | “{common noun after correction}” (.\|, |
| | and) |
| addition of a | insert “{common noun after correction}” |
| common noun | into (beginning\|between “{character}” |
| | and “{character}”\|ending) (.\|, and) |
| deletion of a | delete “{separation character before |
| separation character | correction}” (in a character string\|) (.\|, |
| | and) |
| conversion of a | convert “{separation character before |
| separation character | correction}” (in a character string\|) into |
| | “{separation character after correction}” |
| | (.\|, and) |
| addition of a | insert “{separation character after |
| separation character | correction}” into (beginning\|between |
| | “{character}” and “{character}”\|ending) |
| | (.\|, and) |

In the correction rule description text generation processing (S406), the description text of the correction rule is generated by using the predefined sentence illustrated in Table 4. Here, the character string enclosed in curly brackets { } is treated as a variable and replaced with the number of digits, the common noun, and so on set as the partial character string as the correction target of the correction rule. The character string enclosed in square brackets [ ] is repeated zero times or more according to the number of the variables enclosed in the curly brackets { }. Any one of the character strings enclosed in brackets ( ) and separated by a vertical line “|” is selected depending on the condition. As for the selection condition, in a case of “(in a character string),” the condition for selecting “in a character string” is that it is the correction operation of the correction operation number of “1.” Additionally, in a case of “(.|, and),” the condition for selecting “.” is that it is the correction operation of the greatest correction operation number. Moreover, in a case of “(beginning|between “{character}” and “{character} “|ending),” it is selected according to an insertion place of the character string added.

Here, as an example of the description text generation by the predefined sentence, the description texts generated by the predefined sentences for the correction rule IDs “1,” “2,” and “3” illustrated in Table 3 are described.

The description text of the correction rule of the correction rule ID “1” is described. Under the correction rule, the space (blank character) expressed by the regular expression “¥s” is corrected to “ ” (no character) as the deletion of a separation character in the correction operation number “1.” Therefore, the description text generated by using the predefined sentence is “Delete “space” in a character string.”

The description text of the correction rule of the correction rule ID “2” is described. Under the correction rule, first, as the conversion of a common noun in the correction operation number “1,” the special character “Co., Ltd.” is corrected to “company limited.” Subsequently, as the deletion of a separation character in the correction operation number “2,” the space (blank character) expressed by the regular expression “¥s” is corrected to “ ” (no character). Therefore, the description text generated by using the predefined sentence is “Convert “Co., Ltd.” in a character string to “company limited,” and delete “space.”

The description text of the correction rule of the correction rule ID “3” is described. Under the correction rule, first, the changing of the number of digits of a numeric character string is performed in the correction operation number “1.” The partial character string as the correction target is the partial character string adapting to the regular expression “¥d{1,4}¥D+¥d{1,2}¥D+¥d{1,2}” (a number of one to four digits, a number of one to two digits, and a number of one to two digits are separated by a character string of one or more characters formed of a character other than a number). In addition, the partial character string as the correction target is corrected to the partial character string adapting to the regular expression “¥d{04}¥D+¥d{02}¥D+¥d{02}” (a number of four digits, a number of two digits, and a number of two digits that are zero-padded are separated by a character string of one or more characters formed of a character other than a number). Subsequently, as the deletion of a separation character in the correction operation number “2,” the partial character string adapting to the regular expression “[¥s/]” (either a blank character or/) is corrected to “ ” (no character). Therefore, the description text generated by the predefined sentence is “Convert a number in a character string into “4” digits, “2” digits, “2” digits, and delete “space” and “/”.”

Note that, in the present embodiment, in addition to the description text of the correction rule using the predefined sentence, a character string in a case of applying the correction rule to the character string of system information that the image formation apparatus 100 has, such as a date, as a correction example as a correction result of the correction rule construction is generated as description information.

For example, based on the character string of the date that the system information has (year=2023, month=11, day=14), the character strings to which multiple correction rules are applied, such as “2023/11/14,” “20231114,” “2023.11.14,” and “2023/11/14” are generated. Additionally, based on the character string of the company name that the system information has (name=DEF company limited, corporate status=company limited), the character strings to which multiple correction rules are applied, such as “DEF company limited,” “DEF Co., Ltd.,” and “DEF” are generated. Out of the character strings based on the system information, the character string having a high similarity level with the partial character string as the correction target of the presented correction rule is selected as the pre-correction character string of the correction example. The selection condition may be the character string having the highest similarity level or may be multiple character strings each having a similarity level exceeding a threshold.

### (Presentation of Description Text of Correction Rule and Acceptance of Direction for Correction Rule)

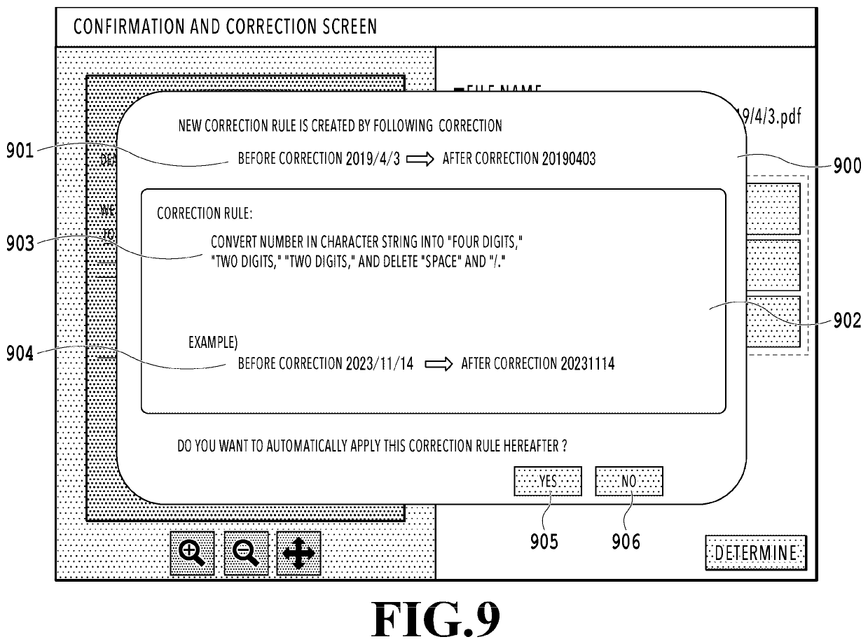

The presentation of the description text of the correction rule (S407) and acceptance of the direction for the correction rule (S408, S409) are described with reference to FIG. 9 and Table 5.

FIG. 9 is a diagram illustrating a screen in a case of the presentation of the description text of the correction rule and the acceptance of the direction for the correction rule according to the present embodiment, which is an example of displaying the description information including the description text for the correction rule of the correction rule ID “3” illustrated in Table 3. In a case where settling processing is performed in the confirmation and correction processing (S402), if the new correction rule is constructed, a correction rule confirmation screen 900 is overlayed and displayed on the confirmation and correction screen. In an upper section on the correction rule confirmation screen 900, a correction result 901 in a case of the correction rule construction is displayed. In a middle section on the correction rule confirmation screen 900, there is a correction rule description area 902 in which a description text 903 of the correction rule and a correction rule application example 904 are displayed. A button 905 and a button 906 are arranged in a lower portion of the correction rule confirmation screen 900, while the button 905 is a button to direct the automatic application setting of the correction rule corresponding to the description information being presented, and the button 906 is a button to direct not to perform the automatic application.

The image processing unit 305 presents the correction result 901 in a case of the correction rule construction and presents the description text 903 of the correction rule and the correction rule application example 904 in the correction rule description area 902 via the displaying and operation unit 123. Additionally, pressing of the button 905 or the button 906 is detected, and the direction on whether to apply the presented correction rule is accepted.

Table 5 is a table illustrating an example of the correction rule after accepting the direction for the automatic application of the correction rule and illustrates the correction rule in a case where the button 905 is pressed, and the direction for the automatic application setting of the correction rule of the correction rule ID “3” is accepted. With the direction for the automatic application setting of the correction rule of the correction rule ID “3” being accepted, “0001_03” is newly set as the correction target ID of the correction rule ID “3.” In the present embodiment, one correction rule is applied at a maximum for each correction target ID, and therefore “0001_03” is deleted from the correction target ID of the correction rule ID “1.” Thus, in a case where a similar document is scanned next time, the correction rule confirmed by the user is applied. Note that, in a case where the button 906 is pressed, and the direction indicating not to automatically apply the correction rule of the correction rule ID “3” is accepted, the newly constructed correction rule of the correction rule ID “3” is deleted.

TABLE 5

| | | | partial | post- |
|---|---|---|---|---|
| | | | character | correction |
| | | correction | string as | partial |
| correction | correction | operation | correction | character |
| rule ID | target ID | number | target | string |
| 1 | 0001_01 | 1 | ¥s | (no character) |
| 2 | 0001_02 | 1 | Co., Ltd. | company limited |
| | | 2 | ¥s | (no character) |
| 3 | 0001_03 | 1 | ¥d{1,4}¥D + | ¥d{04}¥D + |
| | | | ¥d{1,2}¥D + | ¥d{02}¥D + |
| | | | ¥d{1,2} | ¥d{02} |
| | | 2 | [¥s/] | (no character) |

Additionally, although an example of a case where the constructed correction rule is correct is described, for example, in a case where the user corrects “ABC” to “ABC company limited,” the correction rule is constructed according to the correction contents of the addition of a common noun, in which “company limited” is inserted to the ending. However, in a case where the automatic application setting of the above-described correction rule is performed, and in a case where “ABC company limited” and “ABC Co., Ltd.” are character-recognized hereafter as the character string of the same extracted item ID of the similar document, correction to the character string such as “ABC company limited company limited” and “ABC Co., Ltd. company limited” may happen. Additionally, also in a case where “company limited” is put before the company name and in a case where a corporate status is not “company limited,” there is a possibility that the character string correction that is not intended by the user is performed. Therefore, there is a high possibility that the correction rule is not the rule intended by the user. However, in the present embodiment, the user can confirm whether it is the intended correction rule by confirming the generated description text “Insert “company limited” into ending,” and therefore it is possible to suppress the automatic application of an unintended correction rule.

### Effect of Embodiment 1

As described above, according to the present embodiment, it is possible to determine whether the constructed correction rule is the correction rule intended by the user after confirming the description text written in simple words and the application example, and therefore it is possible to suppress the automatic correction based on an incorrect correction rule.

Additionally, in the present embodiment, not only the description text for the correction operation forming the correction rule but also the correction result performed by the user and the application example are displayed together as the description information, and therefore it is possible to improve the level of understanding of the user about the correction rule.

### Embodiment 2

In Embodiment 1, a configuration in which the description text of the correction rule generated based on the predefined sentence is presented to the user, and the direction for the application of the correction rule is accepted is applied. However, the method of generating the description text of the correction rule is not limited to the described method, and for example, a learned natural language generative AI may be used to generate the text describing the correction operation of the correction rule. On the other hand, in any description text generation methods, there is a possibility that the description text becomes complicated in a case where the correction rule includes many correction contents, and the generated description text becomes difficult for the user to understand. Therefore, in the present embodiment, as a means to help the user to understand the description text, a description text with more detailed descriptions is presented in a case where the user feels it is difficult to understand. In the present embodiment, the processing before the correction rule description text generation processing (S406) is the same as Embodiment 1; for this reason, only a part that is a feature is described.

### Feature of Embodiment 2

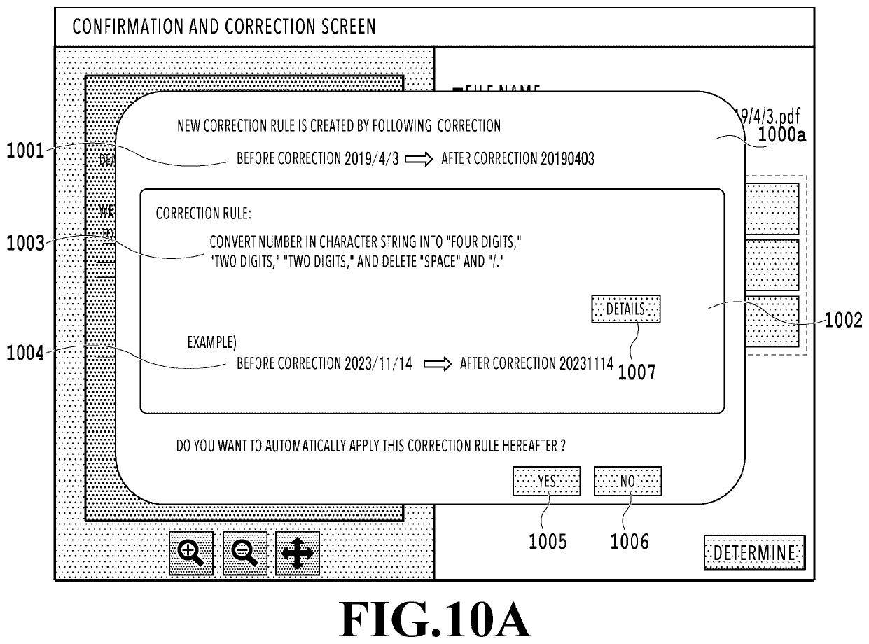

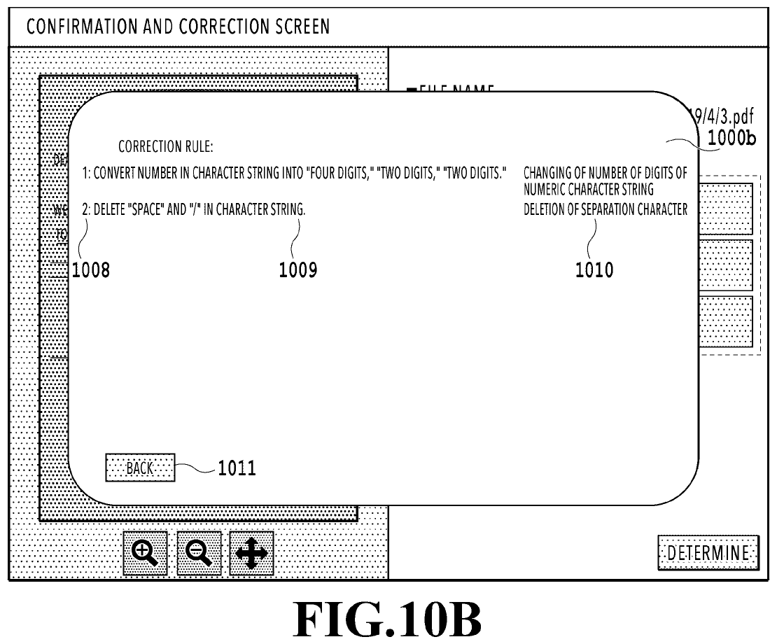

The presentation of the description text of the correction rule and the acceptance of the direction for the correction rule, and processing for updating the correction rule description text according to the present embodiment are described in detail with reference to FIGS. 10A and 10B.

FIG. 10A is a diagram illustrating a screen on which the presentation of the description text of the correction rule, the acceptance of the direction for the correction rule, and acceptance of a direction for presentation of a more detailed description text about the correction rule are performed, which is an example of displaying the description text for the correction rule of the correction rule ID “3” illustrated in Table 3.

As with Embodiment 1, in a case where the settling processing is performed in the confirmation and correction processing (S402), if the new correction rule is constructed, a correction rule confirmation screen 1000a is overlayed and displayed on the confirmation and correction screen. In an upper section on the correction rule confirmation screen 1000a, a correction result 1001 in a case of the correction rule construction is displayed. In a middle section on the correction rule confirmation screen 1000a, there is a correction rule description area 1002, and a correction rule description text 1003 and a correction rule application example 1004 are displayed. A button 1005 and a button 1006 are arranged in a lower portion of the correction rule confirmation screen 1000a, while the button 1005 is a button to direct the automatic application setting of the correction rule corresponding to the description information being presented, and the button 1006 is a button to direct not to perform the automatic application. In the present embodiment, unlike Embodiment 1, a button 1007 is arranged in the correction rule description area 1002. The button 1007 is a button to direct displaying of a details screen of the correction rule description text, and once the pressing of the button 1007 via the displaying and operation unit 123 is detected, the image processing unit 305 displays the details screen of the correction rule description text.

FIG. 10B is a diagram illustrating a screen after the button 1007 is pressed, and a correction rule details screen 1000b is displayed. In a correction operation number area 1008 on the correction rule details screen 1000b, each correction operation number applied to a unit correction operation forming the correction rule is displayed. In a correction operation individual description area 1009, the description text is displayed for each unit correction operation. In a correction content area 1010, the correction contents of each unit correction operation indicated in a column of “correction contents” in Table 3 are displayed. A button 1011 is a button arranged in a lower portion of the correction rule details screen 1000b to direct returning to the correction rule confirmation screen 1000a.

In a case where the user selects and directs one of the correction operation numbers in the correction operation number area 1008 and the description texts in the correction operation individual description area 1009 to request more detailed description, the image processing unit 305 detects the selection and the direction via the displaying and operation unit 123. Then, a detailed description text of the correction operation selected and directed is displayed on the displaying and operation unit 123. The detailed description text may be, for example, examples before and after the correction in the correction operation, highlighting of a portion matching the correction target regular expression of the character string being used in the examples by changing a character color, a font size, a font style (bold, italic, and so on), and the like. Thus, it is easy to determine which part of the character string each correction corrects and how.

Note that, in the descriptions of the present embodiment, a mode of accepting the direction from the user by a button pressing operation and an item selection operation is described. However, for example, a direction for the character string inputted to a text box by the user and the character string inputted by the user with voice recognition may be accepted, and paraphrasing of the description text in an interactive manner, addition of the more detailed description text, and the like may be performed by the learned natural language generative AI. Additionally, the correction result of the character string inputted by the user may be outputted as a correction example.

### Effect of Embodiment 2

As described above, according to the present embodiment, it is possible to determine whether the correction rule is appropriate after confirming whether the constructed correction rule is the correction rule intended by the user by the description text written in simple words, and therefore it is possible to suppress an incorrect automatic correction.

Additionally, in the present embodiment, a part of the description text designated by the user is updated to the detailed description text, and thus it is possible to improve the level of understanding of the correction rule of the user.

### Embodiment 3

In Embodiment 1, in a case where the settling processing is performed in the confirmation and correction processing (S402), if the new correction rule is constructed, the description text of the correction rule is presented to the user on the confirmation and correction screen. Then, the direction to determine whether to automatically apply the constructed correction rule to the extraction target item is accepted. However, in some cases, the constructed correction rule needs to be applied to also another extraction target item in the same document or to all the extraction target items in the documents used by the same user. Additionally, in some cases, if there are multiple competing correction rules for the same extraction target item, the correction rule to be used needs to be selected after confirming the application examples of the multiple correction rules. Therefore, in the present embodiment, candidates of the multiple correction rules are presented for the extraction target item, and a direction for outputting of the application examples of the multiple correction rules, a direction for setting of the automatic application range of the correction rule, and a direction for deletion of the correction rule are accepted. In the following, only the confirmation and correction processing (S402), which is different from Embodiment 1 and is a feature of the present embodiment, including a mode of accepting the various directions by presenting a correction character string candidate and a correction rule candidate of the extraction target item to the user in the confirmation and correction processing (S402) is described.

### Feature of Embodiment 3

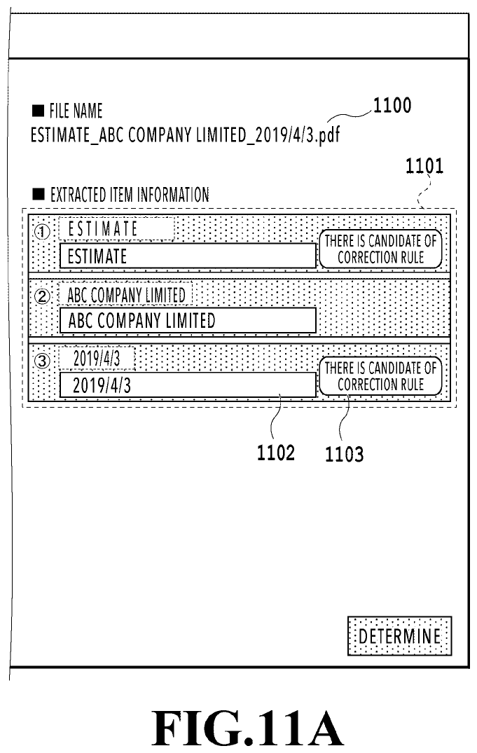

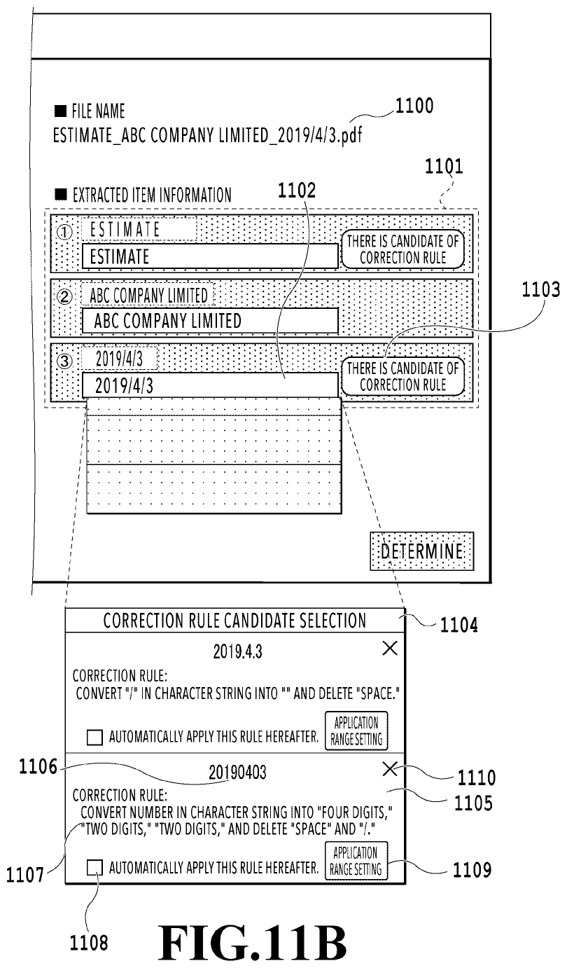

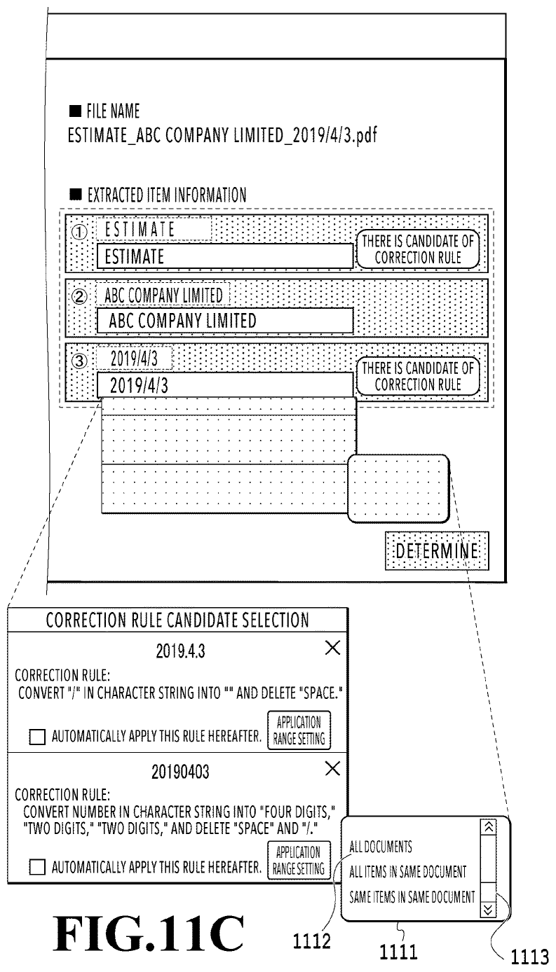

The confirmation and correction processing (S402) according to the present embodiment is described in detail with reference to FIGS. 11A to 11C.

FIG. 11A is a diagram illustrating the confirmation and correction screen and illustrates a screen displayed on the displaying and operation unit 123 in a case where a registered document of the same type as the input document is identified in the character string extraction processing (S401), and the character string is extracted. As with Embodiment 1, a file name text field 1100, an extracted item information area 1101, and an extracted item text field 1102 are displayed. On the other hand, a difference from the confirmation and correction screen in Embodiment 1 is that a correction rule candidate display button 1103 is additionally arranged on the right of the extracted item text field 1102 in the extracted item information area 1101. Note that, in a case where there is no correction rule candidate of the extraction target item, the correction rule candidate display button 1103 is not displayed.

Once the pressing of the correction rule candidate display button 1103 is detected, a correction rule candidate display screen of the pressed extraction target item is overlayed and displayed.

FIG. 11B is a diagram illustrating the confirmation and correction screen on which multiple correction rule candidates are displayed, and a screen on which a correction rule candidate display screen 1104 is overlayed and displayed by pressing of the correction rule candidate display button 1103 targeting the extracted item ID “03” is illustrated. In the present embodiment, two correction rule candidates are registered for the extracted item ID “03,” and both indicate a display in a case where the automatic application setting is not performed.

On the correction rule candidate display screen 1104, a correction rule candidate area 1105 is displayed for each correction rule candidate. In the correction rule candidate area 1105, a correction rule application example 1106, a correction rule description text 1107, a correction rule automatic application setting checkbox 1108, a correction rule application range setting button 1109, and a correction rule deletion button 1110 are displayed and arranged.

In the correction rule application example 1106, the post-correction character string obtained by applying the correction rule to the character string that is the character recognition result of the extraction target item is displayed.

In the correction rule description text 1107, the description text generated by the correction rule description text generation processing (S406) is displayed.

In a state in which the automatic application setting of the correction rule is performed, the correction rule automatic application setting checkbox 1108 is in a state in which the checkbox is checked. Then, once the pressing is detected, the direction for the automatic application setting for the extraction target item is accepted, the automatic application setting is performed, and the checkbox is checked. In a case where the automatic application setting is performed, the character string displayed in the extracted item text field 1102 is corrected in accordance with the correction rule, and likewise, the character string displayed in the file name text field 1100 is also corrected.

Once the pressing of the correction rule application range setting button 1109 is detected, as illustrated in FIG. 11C, an application range setting screen 1111 is overlayed and displayed on the confirmation and correction screen. On the application range setting screen 1111, an application range display name area 1112 and an application range setting sliding bar 1113 are displayed and arranged. Once a direction for setting of the application range is accepted by changing the position of the application range setting sliding bar 1113, the application range setting is performed according to an application range display name displayed in a horizontal position of the application range setting sliding bar 1113.

Once the pressing of the correction rule deletion button 1110 is detected, a deletion direction is accepted, and the correction rule as the target is deleted.

In the correction rule candidate area 1105, once selection of a portion other than the correction rule automatic application setting checkbox 1108, the correction rule application range setting button 1109, and the correction rule deletion button 1110 is detected, a direction for application of the correction rule is accepted. Then, the character string displayed in the extracted item text field 1102 is corrected in accordance with the correction rule, and likewise, the character string displayed in the file name text field 1100 is also corrected.

### Effect of Embodiment 3

As described above, according to the present embodiment, it is possible to determine whether the correction rule is appropriate after confirming whether the constructed correction rule is the correction rule intended by the user by the description text written in simple words, and therefore it is possible to suppress an incorrect automatic correction.

Additionally, in the present embodiment, a configuration in which multiple correction rule candidates are held for one extracted item, and selection of the correction rule automatically applied is accepted after presenting the correction results in a case where the multiple correction rule candidates are applied to the character string. Thus, the user can use the competing correction rules selectively, it is possible to easily perform the setting of the correction rule intended by the user even in a document that requires a variety of corrections, and it is possible to reduce the work burden of the character string correction by the user. Additionally, since it is possible to set the application range of the correction rule, it is also possible to reduce the time to confirm an unnecessary description text of the correction rule, the time to confirm the same description text of the correction rule, and the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to make it easy for a user to understand a constructed correction rule.

This application claims the benefit of Japanese Patent Application No. 2025-077322, filed May 7, 2025, which is hereby incorporated by reference herein in its entirety.

What is claimed is:

1. An information processing apparatus comprising at least one memory and at least one processor which function as:
an obtainment unit configured to obtain a character string included in an inputted document image and a post-correction character string corrected from the character string by a user;
a generation unit configured to generate a correction rule to obtain the post-correction character string from the character string based on the obtained character string and post-correction character string; and
an output unit configured to output description information including a description text of the generated correction rule.

2. The information processing apparatus according to claim 1, further comprising:
an acceptance unit configured to display the description information and accept a direction on whether to utilize the correction rule from the user.

3. The information processing apparatus according to claim 2, wherein the direction on whether to utilize the correction rule is a direction on whether to apply the correction rule to a character string included in another document image.

4. The information processing apparatus according to claim 2, wherein
the generation unit can generate the one or more correction rules for each predetermined extracted item in the character string, and
the acceptance unit displays the description information of the one or more correction rules generated for the one extracted item.

5. The information processing apparatus according to claim 4, wherein
the plurality of correction rules generated for the same extracted item are correction rules competing with each other.

6. The information processing apparatus according to claim 2, wherein
the acceptance unit accepts a direction for deletion of the correction rule from the user.

7. The information processing apparatus according to claim 2, wherein
the acceptance unit accepts a user input designating a part of the description information, and
the output unit outputs additional information related to the part of the description information.

8. The information processing apparatus according to claim 2, wherein
the acceptance unit accepts an application range of the correction rule from the user.

9. The information processing apparatus according to claim 1, wherein
the generation unit generates the correction rule based on a predetermined unit correction operation forming the correction performed by the user, and
the output unit outputs a description text for each predetermined unit correction operation included in the correction rule as the description information.

10. The information processing apparatus according to claim 9, wherein
the generation unit performs identification of the predetermined unit correction operation based on regular expressions before and after correction that are registered for each predetermined unit correction operation, where the regular expressions are the character string and the post-correction character string.

11. The information processing apparatus according to claim 1, wherein
the output unit outputs a result of applying the correction rule to the character string as the description information.

12. The information processing apparatus according to claim 1, wherein
the output unit outputs a result of applying the correction rule to system information held by the information processing apparatus as the description information.

13. The information processing apparatus according to claim 1, further comprising:
an acceptance unit configured to accept a user input designating a part of the description information, wherein
the output unit outputs a part of the description information designated by the user in a different expression.

14. The information processing apparatus according to claim 1, wherein
the character string is a character string obtained by performing character recognition processing on the inputted document image.

15. An information processing method, comprising:
obtaining a character string included in an inputted document image and a post-correction character string corrected from the character string by a user;
generating a correction rule to obtain the post-correction character string from the character string based on the character string and the post-correction character string; and
outputting description information including a description text of the correction rule generated by the generating.

16. A non-transitory computer readable storage medium storing a program for causing a computer to perform an information processing method comprising:
obtaining a character string included in an inputted document image and a post-correction character string corrected from the character string by a user;
generating a correction rule to obtain the post-correction character string from the character string based on the character string and the post-correction character string; and
outputting description information including a description text of the correction rule generated by the generating.
